(19) United States
(12) Patent Application Publication
(10) Pub. No.: US 2017/0069218 A1
(43) Pub. Date: Mar. 9, 2017

(54) L-V-C OPERATING SYSTEM AND UNMANNED AERIAL VEHICLE TRAINING/TESTING METHOD USING THE SAME

(71) Applicant: INDUSTRY-UNIVERSITY COOPERATION FOUNDATION KOREA AEROSPACE UNIVERSITY, Goyang-si (KR)

(72) Inventors: Sukhoon SHIN, Goyang-si (KR); Eunbog LEE, Goyang-si (KR); Kangmoon PARK, Goyang-si (KR); Jeongho KIM, Seoul (KR); Sunho HA, Sancheong-gun (KR); Hyungeun KIM, Goyang-si (KR); Sungdo CHI, Goyang-si (KR)

(21) Appl. No.: 15/357,235

(22) Filed: Nov. 21, 2016

Related U.S. Application Data
(63) Continuation of application No. PCT/KR2015/010675, filed on Oct. 8, 2015.

(30) Foreign Application Priority Data
Sep. 7, 2015 (KR) 10-2015-0126061

(51) Int. Cl. G09B 9/08; G09B 9/46; G09B 9/30; B64C 39/02; G05D 1/00

(52) U.S. Cl. CPC G09B 9/085; B64C 39/024; G05D 1/0016; G09B 9/302; G09B 9/46

(57) ABSTRACT

Provided is a L-V-C (Live-Virtual-Constructive) operating system for providing a L-V-C-based unmanned aerial vehicle (UAV) training/testing environment, including: a synthetic environment control unit that exchanges information with a Live environment, a Virtual environment, and a Constructive environment and allows a UAV of the Live environment or the Virtual environment to interwork with the Live environment, the Virtual environment, and the Constructive environment.

### CROSS-REFERENCE TO RELATED APPLICATION

This application is a continuation of PCT Patent Application No. PCT/KR2015/010675 filed on Oct. 8, 2015, which claims priority to and the benefit of Korean Patent Application No. 10-2015-0126061 filed on Sep. 7, 2015, and the entire disclosures of which are incorporated herein by reference.

### TECHNICAL FIELD

The present disclosure relates to a L-V-C operating system for providing a L-V-C-based unmanned aerial vehicle (UAV) training/testing environment and a UAV training/testing method using the same.

### BACKGROUND

In the field of modeling and simulation (M&S) for national defense, a testing and training method using simulations in a live environment, a virtual environment, and a constructive environment has been applied.

Firstly, a live simulation refers to a simulation, such as actual flight training, in which an operator operates an actual object. The live simulation provides high-level realism but is limited in time and costs. Next, a virtual simulation refers to a simulation, such as flight simulation training, in which a virtual model is operated in a visualized environment. The virtual simulation requires low costs and a short time but makes it difficult to experience various scenarios. Finally, a constructive simulation refers to a simulation, such as a combat flight simulation game, in which abstract model and environment are simulated. The constructive simulation makes it possible to test various scenarios at a high speed with low costs but cannot provide realism.

Meanwhile, an unmanned aerial vehicle (UAV) operated in a remote outdoor environment involves some risks including: loss of life/property caused by a communication link fault, a time delay, a ground structure, a flying object, and a system failure; robbery, loss and damage caused by man-made and environmental factors; and liabilities demanded by individuals and society. Therefore, a procedure of studying and verifying a technology for solving the above-described risks needs to be performed priorly. Accordingly, in a lot of existing studies, initial design and verification tests have been conducted in an indoor environment in which environmental factors can be easily controlled with fewer risk factors. However, it has been difficult to overcome spatial constraints of the indoor environment.

The background technology of the present disclosure is disclosed in Korean Patent Application No. 2013-0058922 (entitled “Ground control standard working system of unmanned aerial vehicles”) and Korean Patent Application No. 2013-0031887 (entitled “Integrated flight control computer system for an unmanned aerial vehicle and testing method for the same”).

### DISCLOSURE OF THE INVENTION

### Problems to be Solved by the Invention

The present disclosure is provided to solve the above-described problem, and provides a L-V-C (Live-Virtual-Constructive) operating system for providing an unmanned aerial vehicle (UAV) training/testing environment based on an efficient L-V-C interworking and a UVA training/testing method using the same in order to construct a UAV training/testing environment in which risks of a UAV in an outdoor training/testing environment are overcome and spatial constraints of an indoor environment are solved.

Further, the present disclosure provides a L-V-C operating system for providing a L-V-C-based UAV training/testing environment capable of constructing a synthetic environment control system for L-V-C interworking which has been used as a technology for solving spatial constraints of an indoor environment in an indoor UAV training/testing environment, and a UVA training/testing method using the same.

Furthermore, the present disclosure provides a L-V-C operating system for providing a L-V-C-based UAV training/testing environment capable of constructing a training support system to support training and practice in an UAV training/testing environment, and a UVA training/testing method using the same.

However, problems to be solved by the present disclosure are not limited to the above-described problems. Although not described herein, other problems to be solved by the present disclosure can be clearly understood by those skilled in the art from the following descriptions.

### Means for Solving the Problems

According to a first aspect of the present disclosure, there is provided a L-V-C (Live-Virtual-Constructive) operating system for providing a L-V-C-based unmanned aerial vehicle (UAV) training/testing environment, including: a synthetic environment control unit that exchanges information with a Live environment, a Virtual environment, and a Constructive environment and allows a UAV of the Live environment or the Virtual environment to interwork with the Live environment, the Virtual environment, and the Constructive environment. The synthetic environment control unit includes: a position-tracking module configured to acquire position/posture information of the UAV of the Live environment and scale the position/posture information to correspond to a virtual space of the Virtual environment; an event propagation module configured to receive information about an event if the event occurs in the Constructive environment and generate information changed by the event; a spatial information module configured to generate updated information about an object and a space/environment and reflect the updated information to the Virtual environment and the Constructive environment in consideration of the scaled position/posture information of the UAV and the information changed by the event; and a model control module configured to generate a signal for controlling the UAV of the Live environment on the basis of the updated information.

According to an exemplary embodiment of the present disclosure, the model control module may convert a UAV control command determined on the basis of the virtual space of the Virtual environment to the signal for controlling the UAV of the Live environment while reflecting spatial constraints of the Live environment.

According to an exemplary embodiment of the present disclosure, the spatial information module may manage and provide position/posture information of a UAV and a mobile obstacle which can be visualized in the virtual space of the Virtual environment, and spatial/environmental information.

According to an exemplary embodiment of the present disclosure, the updated information may include position/posture information of a UAV and a mobile obstacle and spatial/environmental information provided to the Virtual environment, and position/posture information of a UAV and a mobile obstacle and spatial/environmental information provided to the Constructive environment.

According to an exemplary embodiment of the present disclosure, the L-V-C operating system according to the first aspect may include a training support unit. The training support unit includes: a scenario authoring unit configured to provide a scenario for a UAV trainee; an event status injection unit configured to generate an event according to the scenario provided from the scenario authoring unit and provide the event to the Constructive environment; a training result collection unit configured to collect an operation result of a trainee in response to the event from the Constructive environment; a training result analysis unit configured to provide analysis information obtained by analyzing the collected training result; and a user interface provided to see the scenario and the analysis information.

According to an exemplary embodiment of the present disclosure, the Live environment is a limited space that allows an actual UAV to be operated and may include a three-dimensional position-tracking sensor configured to provide information about position/posture of the UAV in real time, the Virtual environment may include a display unit configured to provide a three-dimensionally visualized virtual space on a screen and a three-dimensional visualization program unit having a UAV visualization function, a mobile obstacle visualization function, a topography/landmark visualization function, and a weather visualization function, and the Constructive environment may include a simulation engine configured to derive a physical interaction result between an object and a space/environment through a computer simulation.

According to a second aspect of the present disclosure, there is provided a L-V-C-based UAV training/testing method using a L-V-C operating system according to the first aspect of the present disclosure, including: a first step in which the L-V-C operating system receives a scenario input by a trainer through a user interface and assigns a training objective according to the scenario; a second step in which a UAV is operated in a Live environment according to a control input received through a trainee interface controlled by a trainee; and a third step in which if an event occurs with respect to a UAV model in a Constructive environment, the L-V-C operating system receives information about the event from the Constructive environment and provides the information to the trainee interface, and receives a control input, with respect to the UAV in the Live environment, made on the trainee interface in response to the provided event and operates the UAV in the Live environment by direct control in consideration of effects of the control input and the event.

According to an exemplary embodiment of the present disclosure, the L-V-C-based UAV training/testing method according to the second aspect of the present disclosure may further include: a fourth step in which the L-V-C operating system collects position information of the UAV operated in the Live environment and determines whether the assigned training objective is achieved on the basis of the collected position information; and a fifth step in which if it is determined that the assigned training objective is not achieved, the L-V-C operating system is controlled to return to the second step and repeat the second step to the fourth step until the training objective is achieved.

According to an exemplary embodiment of the present disclosure, in the fifth step, if it is determined that the assigned training objective is achieved, the L-V-C operating system may report a training performance analysis result to the trainer through a trainer interface and then end a Live-Constructive-based crisis response training process.

According to a third aspect of the present disclosure, there is provided a L-V-C-based UAV training/testing method using a L-V-C operating system according to the first aspect of the present disclosure, including: a first step in which the L-V-C operating system receives a scenario input by a trainer through a user interface and assigns a training objective according to the scenario; a second step in which a UAV is operated in a Live environment according to a control input received through a trainee interface controlled by a trainee and the L-V-C operating system operates a UAV in a Virtual environment; and a third step in which if an event occurs with respect to a UAV model in a Constructive environment, the L-V-C operating system receives information about the event from the Constructive environment and displays the event in a virtual space of the Virtual environment, and receives a control input made on the trainee interface in response to the displayed event and operates the UAV in the Live environment and the Virtual environment by direct control in consideration of effects of the control input and the event.

According to an exemplary embodiment of the present disclosure, the L-V-C-based UAV training/testing method according to the third aspect of the present disclosure may further include: a fourth step in which the L-V-C operating system collects one or more of position information of the UAV operated in the Live environment and position information of the UAV operated in the Virtual environment and determines whether the assigned training objective is achieved on the basis of the collected position information; and a fifth step in which if it is determined that the assigned training objective is not achieved, the L-V-C operating system is controlled to return to the second step and repeat the second step to the fourth step until the training objective is achieved.

According to an exemplary embodiment of the present disclosure, in the fifth step, if it is determined that the assigned training objective is achieved, the L-V-C operating system may report a training performance analysis result to the trainer through a trainer interface and then end a Live-Virtual-Constructive-based virtual mission training process.

Further, according to an aspect of the present disclosure, there is provided a computer-readable storage medium in which a program for executing a L-V-C-based UAV training/testing method according to the second aspect of the present disclosure or a L-V-C-based UAV training/testing method according to the third aspect of the present disclosure on a computer is stored.

The above-described exemplary embodiments are provided by way of illustration only and should not be construed as liming the present disclosure. Besides the above-described exemplary embodiments, there may be additional exemplary embodiments described in the accompanying drawings and the detailed description.

### Effects of the Invention

According to at least one of the aspects of the present disclosure, spatial constraints of an indoor training/testing environment in a Live environment can be effectively compensated by virtual experiences in a Virtual environment.

Further, according to at least one of the aspects of the present disclosure, a diversity of training/testing can be secured by weather/obstacle events provided in a Constructive environment.

Furthermore, according to at least one of the aspects of the present disclosure, it is easy to plan a training scenario and collect/analyze a result and it is possible to maximize a UAV training effect on a trainee.

### BRIEF DESCRIPTION OF THE DRAWINGS

FIG. 1 is a configuration view of a L-V-C environment provided in a L-V-C operating system for providing a L-V-C-based UAV training/testing environment in accordance with an exemplary embodiment of the present disclosure;

FIG. 2 is a configuration view illustrating the L-V-C operating system illustrated in FIG. 1;

FIG. 3 is a configuration view illustrating a synthetic environment control unit of the L-V-C operating system illustrated in FIG. 2;

FIG. 4 is a configuration view illustrating a training support unit of the L-V-C operating system illustrated in FIG. 2;

FIG. 5 is a flowchart illustrating a Live-based basic pilot training process in a L-V-C-based UAV training/testing method in accordance with an exemplary embodiment of the present disclosure;

FIG. 6 is a flowchart illustrating a Constructive-based basic pilot training process in the L-V-C-based UAV training/testing method in accordance with an exemplary embodiment of the present disclosure;

FIG. 7 is a flowchart illustrating a Live-Constructive-based crisis response training process in the L-V-C-based UAV training/testing method in accordance with an exemplary embodiment of the present disclosure; and

FIG. 8 is a flowchart illustrating a Live-Virtual-Constructive-based virtual mission training process in the L-V-C-based UAV training/testing method in accordance with an exemplary embodiment of the present disclosure.

### MODE FOR CARRYING OUT THE INVENTION

Hereinafter, exemplary embodiments of the present disclosure will be described in detail with reference to the accompanying drawings. In the following, detailed descriptions of functions or configurations known in the art may be omitted to avoid obscuring the subject matter of the present disclosure.

In the present specification, if any one component “transmits” data or a signal to another component, the one component may directly transmit the data or signal to the other component or may transmit the data or signal to the other component through at least one another component.

The present disclosure relates to a L-V-C operating system for providing a L-V-C-based UAV training/testing environment using an indoor space for test and training with a UAV such as a drone, and a UAV training/testing method using the same. More specifically, the present disclosure relates to a L-V-C operating system for providing a L-V-C-based UAV training/testing environment in which a safe and effective indoor test and training can be carried out by grafting a space for a safe indoor test with an actual UAV in a virtual reality and simulation technology using computer software, and a UAV training/testing method using the same.

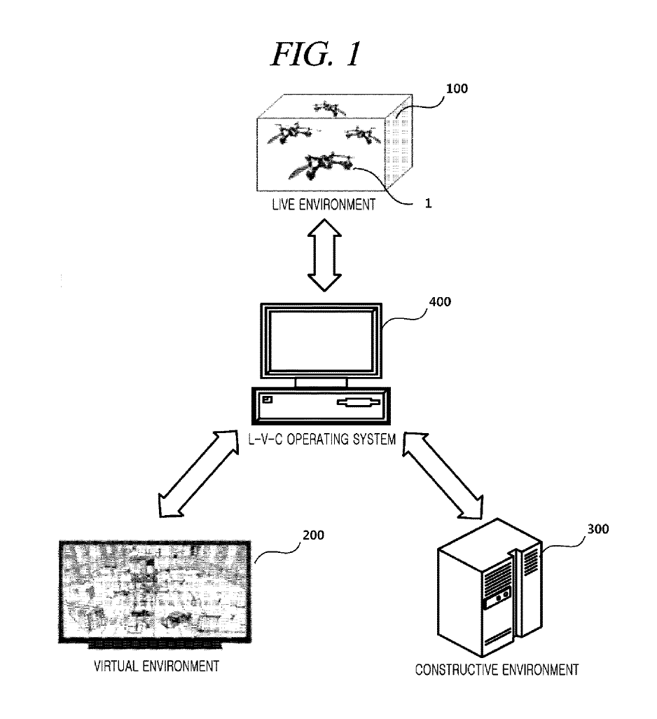

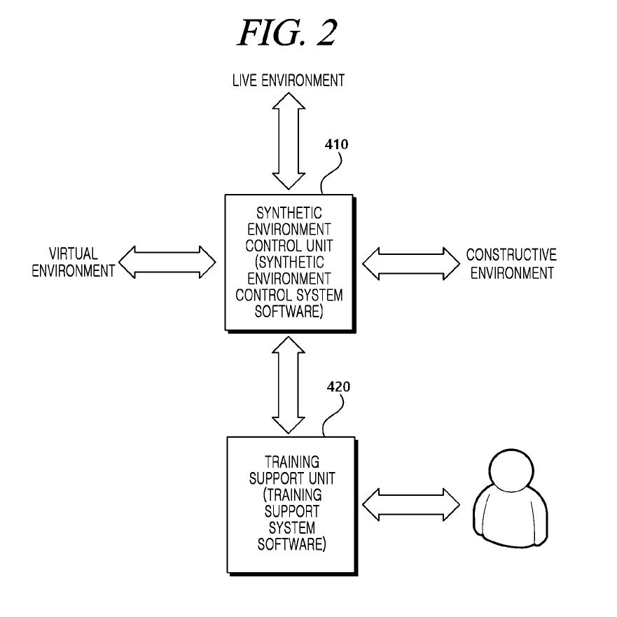

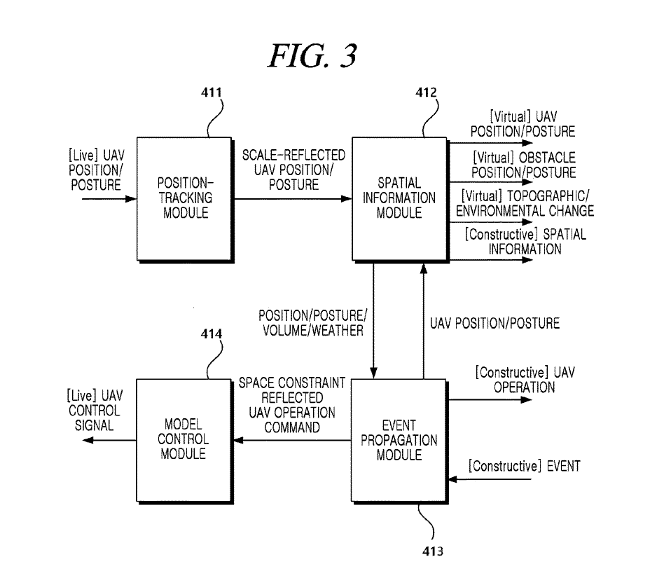

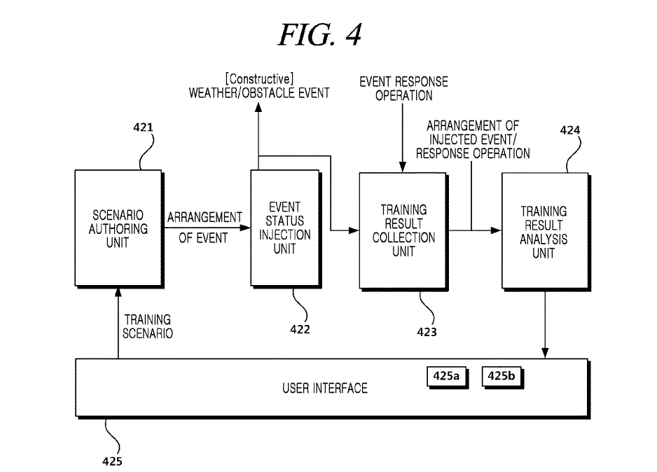

FIG. 1 is a configuration view of a L-V-C environment (hereinafter, referred to as “L-V-C-based UAV training/testing environment) provided in a L-V-C operating system (hereinafter, referred to as “L-V-C operating system”) for providing a L-V-C-based UAV training/testing environment in accordance with an exemplary embodiment of the present disclosure. FIG. 2 is a configuration view illustrating the L-V-C operating system 400 illustrated in FIG. 1. FIG. 3 is a configuration view illustrating a synthetic environment control unit 410 of the L-V-C operating system 400 illustrated in FIG. 2. FIG. 4 is a configuration view illustrating a training support unit 420 of the L-V-C operating system 400 illustrated in FIG. 2.

Referring to FIG. 1, a L-V-C-based UAV training/testing environment includes a Live environment 100, a Virtual environment 200, a Constructive environment 300, and the L-V-C operating system 400. Since the L-V-C operating system 400 uses an indoor space and software, it is suitable for a UAV education and training and can be used in a test/verification study.

Herein, the Live environment 100 may include a three-dimensional position-tracking sensor which can provide in real time a current position/posture of a UAV to a space where an actual UAV can be operated. Further, the Live environment 100 may include a safety net. The Live environment 100 may be a space provided indoors and may be provided with adjustment to reduce its scale compared to a space (environment) actually provided outdoors in consideration of constraints of an indoor space. For example, although the Live environment 100 may be provided as a space having an area of 10 m×10 m, but the Virtual environment 200 may be expressed as a space having an area of 1 km×1 km so as to correspond to the space actually provided outdoors. In the synthetic environment control unit 410, a position-tracking module 411 to be described later may have a scaling function of compensating a spatial difference between the Live environment 100 and the Virtual environment 200.

The Virtual environment 200 functions to provide a three-dimensional visualization environment, and may include a display unit (immersive display device) including a large screen or a head mount display and a three-dimensional visualization program unit (software).

The Constructive environment 300 functions to provide information that enables interactions between a virtual space and a UAV, an obstacle, or others to be continuously visualized through a high-speed computer simulation, and may include a UAV model, an obstacle model, a weather model, a topography/landmark model, and a simulation engine configured to implement each model and obtain results of interactions.

The L-V-C operating system 400 provides a synthetic environment for a UAV training/test by Live-Virtual-Constructive environment interworking.

For example, the environments 100, 200, and 300 can be connected to the L-V-C operating system 400 through a general TCP-IP network. In this case, as a higher frequency band is secured, a training/testing environment can be provided more smoothly.

Referring to FIG. 2, the L-V-C operating system 400 may include the synthetic environment control unit 410 that functions to resolve spatial and timing differences among the environments 100, 200, and 300. The synthetic environment control unit 410 may exchange information with the Live environment 100, the Virtual environment 200, and the Constructive environment 300 and allows a UAV of the Live environment or the Virtual environment to interwork with the Live environment, the Virtual environment, and the Constructive environment. Further, the L-V-C operating system 400 may include the training support unit 420 that provides a trainee with a training scenario authoring function and a training result analysis function for a smooth training/test.

Referring to FIG. 3, the synthetic environment control unit 410 may include the position-tracking module 411 that functions to adjust a scale (ratio) of position/posture information of a UAV of the Live environment 100 depending on a space of the Virtual environment 200.

Further, the synthetic environment control unit 410 may include a spatial information module 412 that manages and provides position/posture information of all components (including a UAV and an obstacle) visualized in the ever-changing Virtual environment 200 and space and environment information (including changes in topography/environment and spatial information) so as to be reflected in the Virtual environment 200. The spatial information module 412 may generate updated information about an object (a UAV, a mobile obstacle, etc.) and a space/environment (topography, a stationary obstacle, a weather condition, etc.) and reflect the updated information to the Virtual environment 200 and the Constructive environment 300 in consideration of position/posture information of the UAV scaled by the position-tracking module 411 and information changed by an event. The spatial information module 412 may be a module configured to store, manage (update), and provide information about a virtual space (e.g., three-dimensional topography/landmark information, position/posture/volume information of a UAV, position/posture/volume information of a mobile obstacle, and weather (rain/wind/illuminance)) as a UAV operation environment in the Virtual environment 200 and the Constructive environment 300. The Virtual environment 200 may be displayed as real-time three-dimensional graphics using the data of the spatial information module 412.

Furthermore, the synthetic environment control unit 410 may include an event propagation module 413 that functions to receive information about an event, such as weather, an obstacle, a danger, etc., occurring in the Constructive environment 300 and controls the information to affect a UAV of the Live environment 100. If an event occurs in the Constructive environment 300, the event propagation module 413 may receive information about the event and generate information changed by the event (e.g., posture/position information of the UAV changed by the event). For example, the event propagation module 413 may transfer the information changed by the event to the spatial information module 412, receive updated information about the Virtual environment 200 and/or the Constructive environment 300, and then modify an operation of the UAV and transfer information about the modified operation to a model control module 414 in order to suppress in advance an overlap of volumes beyond the spatial constraints caused by the event in the Live environment 100. Herein, the updated information may include position/posture information of a UAV and a mobile obstacle and spatial/environmental information provided to the Virtual environment, and position/posture information of a UAV and a mobile obstacle and spatial/environmental information provided to the Constructive environment.

Moreover, the synthetic environment control unit 410 may include the model control module 414 that converts a UAV control command determined on the basis of a viewable screen of the Virtual environment 200 to a signal for controlling an actual UAV of the Live environment 100. The model control module 414 may generate a signal for controlling a UAV of the Live environment on the basis of updated information about an object and a space/environment generated by the spatial information module 412. As described above, the model control module 414 may receive an operation command reflecting the modified operation of the UAV from the event propagation module 413 in order to suppress in advance an overlap of volumes beyond the spatial constraints caused by the event in the Live environment 100 and then generate the signal for controlling the UAV of the Live environment 100 on the basis of the operation command. That is, the model control module 414 may convert a UAV control command determined on the basis of a virtual space of the Virtual environment 200 to a signal for controlling a UAV of the Live environment 100 while reflecting spatial constraints of the Live environment 100. Further, similar to the position-tracking module 411, the model control module 414 may perform scaling in consideration of a spatial difference between the Live environment 100 and the Virtual environment 200.

Referring to FIG. 4, the training support unit 420 may include: a scenario authoring unit 421 configured to author a training/testing scenario for a trainee and provide the scenario to an event status injection unit 422; the event status injection unit 422 configured to generate a virtual event, such as weather, an obstacle, an abnormality of the UAV, according to the scenario authored by the scenario authoring unit and provide the event to the Constructive environment 300; a training result collection unit 423 configured to collect an operation result of the trainee in response to the event injected by the event status injection unit 422 from the Constructive environment 300; a training result analysis unit 424 configured to provide analysis in various points of view; and a user interface 425 provided to see the authored training scenario and a training performance analysis result.

Meanwhile, hereinafter, a L-V-C-based UAV training/testing method in accordance with an exemplary embodiment of the present disclosure will be described. This method uses the above-described L-V-C operating system (apparatus) and thus includes technical features identical or corresponding to those of the L-V-C operating system (apparatus). Therefore, components identical or similar to those explained above will be assigned identical reference numerals, and explanation thereof will be briefly provided or omitted.

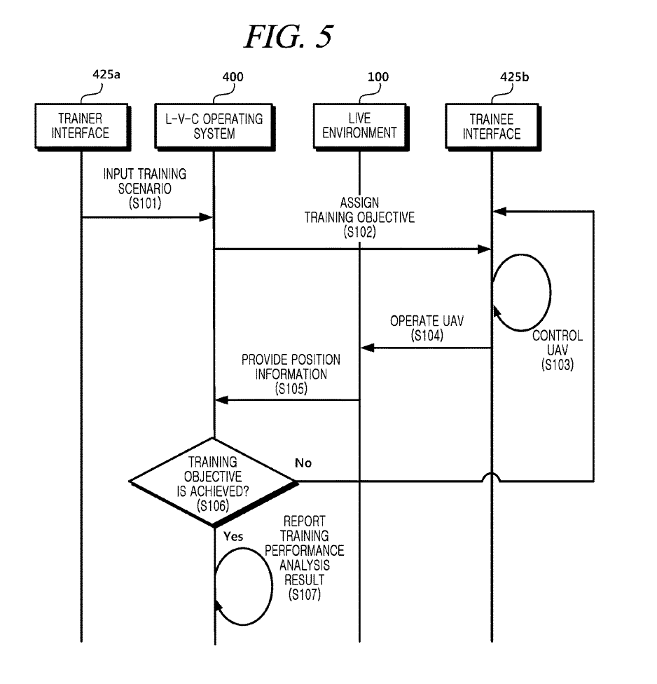

FIG. 5 is a flowchart illustrating a Live-based basic pilot training process in a L-V-C-based UAV training/testing method in accordance with an exemplary embodiment of the present disclosure. Referring to FIG. 5, the L-V-C operating system 400 is provided with a scenario input by a trainer through a trainer interface 425a in the user interface 425 (S101).

After S101, the L-V-C operating system 400 assigns a training objective according to the scenario provided in S101 (S102).

After S102, if a trainee inputs a control signal for a UAV 1 using a trainee interface 425b such as a controller (S103), the UAV of the Live environment 100 may be operated in response to the control signal (S104). For example, the UAV 1 may be operated by directly receiving the control signal input by the trainee. Further, the control signal related to the operation of the UAV 1 may also be transferred to the L-V-C operating system 400. However, the operation method of the UAV 1 is not limited thereto. As another example, the control signal related to the operation of the UAV 1 may be transferred to the UAV 1 through the L-V-C operating system 400.

After S104, the L-V-C operating system 400 collects position/posture information of the UAV 1 operated in the Live environment 100 (S105). For example, the L-V-C operating system 400 may collect position/posture information of the UAV 1 through the three-dimensional position-tracking sensor provided in the Live environment 100.

After S105, the L-V-C operating system 400 determines whether the training objective assigned in S102 is achieved on the basis of the collected position/posture information (S106).

If it is determined in S106 that the assigned training objective is not achieved, the L-V-C operating system 400 is controlled to return to S103 and repeat S103 to S106 until the training objective is achieved.

If it is determined in S106 that the assigned training objective is achieved, the L-V-C operating system 400 reports a training performance analysis result to the trainer through the trainer interface 425a (S107) and then ends a Live-based basic pilot training process.

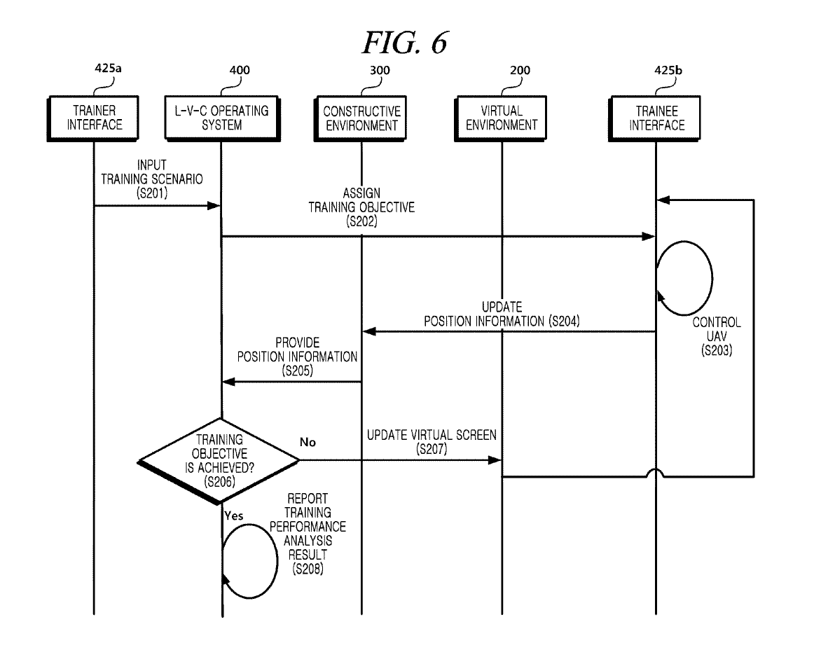

FIG. 6 is a flowchart illustrating a Virtual-Constructive-based basic pilot training process in the L-V-C-based UAV training/testing method in accordance with an exemplary embodiment of the present disclosure. Referring to FIG. 6, S201 and S202 of a Virtual-Constructive-based basic pilot training process may correspond to S101 and S102 shown in FIG. 5.

After S202, if the trainee inputs a control signal for the UAV 1 using the trainee interface 425b such as a controller (S203), position/posture information of a UAV model of the Constructive environment 300 may be updated in response to the control signal (S204) and the L-V-C operating system 400 may collect the position/posture information of the UAV model of the Constructive environment 300 (S205). For example, the control signal for the UAV 1 may be directly transmitted from the trainee interface 425b to the Constructive environment 300 or may be transmitted through the L-V-C operating system 400.

After S205, the L-V-C operating system 400 determines whether the training objective assigned in S202 is achieved (S206).

If it is determined in S206 that the assigned training objective is not achieved, the L-V-C operating system 400 repeats S203 to S207 until the training objective is achieved by updating a virtual screen of the Virtual environment 200 so as to correspond to object information (e.g., position/posture information about a UAV and a mobile obstacle) and space/environment models in the Constructive environment 300 (S207) and then performing the step S203 of receiving a new UAV control signal for the UAV model of the Constructive environment 300.

If it is determined in S206 that the assigned training objective is achieved, the L-V-C operating system 400 reports a training performance analysis result to the trainer through the trainer interface 425a (S208) and then ends a Virtual-Constructive-based basic pilot training process.

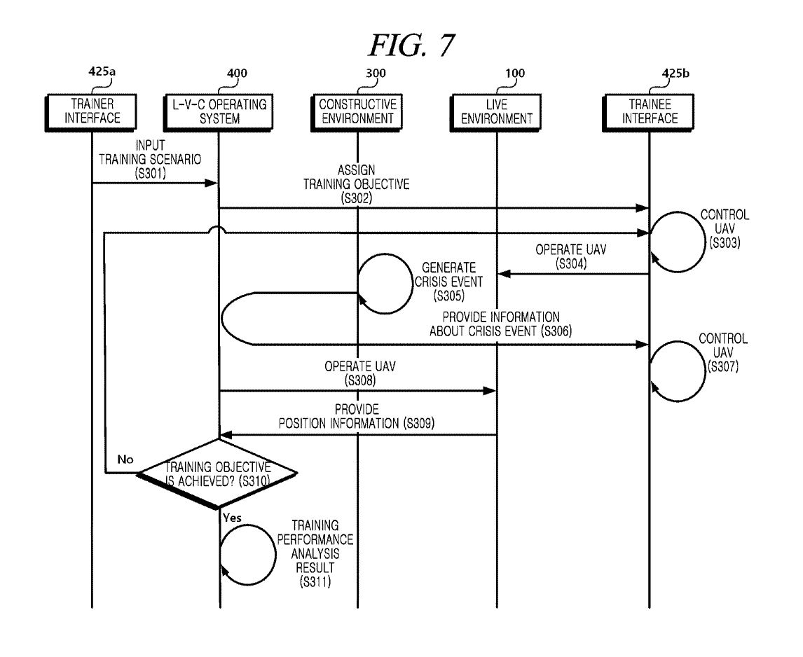

FIG. 7 is a flowchart illustrating a Live-Constructive-based crisis response training process in the L-V-C-based UAV training/testing method in accordance with an exemplary embodiment of the present disclosure. Referring to FIG. 7, S301 to S303 corresponding to S101 to S103 shown in FIG. 5 are performed in the beginning, and then the actual UAV 1 of the Live environment 100 is operated in response to a control input received through the trainee interface 425b including a controller or the like (S304).

During or after S304, if an event related to the UAV model occurs in the Constructive environment, the L-V-C operating system 400 receives information about the event, such as a crisis, from the Constructive environment 300 and generates event information (S305), and then provides the information about the event to the trainee through the trainee interface 425b (S306). For example, the trainee interface 425b may include a controller configured to generate a signal for controlling the UAV 1 and an event information providing unit configured to receive information about an event. For example, the event information providing unit may provide the trainee with the information about the event in various forms such as visual form (video, image, text, etc.) and audio form (guide voice, sound effect, etc.).

In response to the event, such as a crisis, provided in S306, the trainee may make a control input with respect to the UAV 1 operated in the Live environment 100 through the trainee interface 425b (S307). The L-V-C operating system 400 receives the control input with respect to the UAV 1 and operates the UAV in the Live environment 100 by direct control in consideration of effects of the control input and the event (S308). To be specific, in S308, the UAV 1 may be operated by direct control matched with the event, such as a crisis, related to the UAV 1 of the Live environment 100 by the synthetic environment control unit 410 of the L-V-C operating system 400.

After S308, the L-V-C operating system 400 may collect position information of the UAV 1 operated in the Live environment 100 (S309). However, S309 is not limited to be performed only after S308. For example, position information of the UAV 1 of the Live environment 100 may be collected regularly while the other steps are performed, or may be collected frequently if necessary. Further, the L-V-C operating system 400 determines whether the training objective assigned in S302 is achieved on the basis of the collected position information (S310).

If it is determined in S310 that the assigned training objective is not achieved, the L-V-C operating system 400 is controlled to return to S303 and repeat S303 to S310 until the training objective is achieved.

If it is determined in S310 that the assigned training objective is achieved, the L-V-C operating system 400 reports a training performance analysis result to the trainer through the trainer interface 425a (S311) and then ends a—Live-Constructive-based crisis response training process.

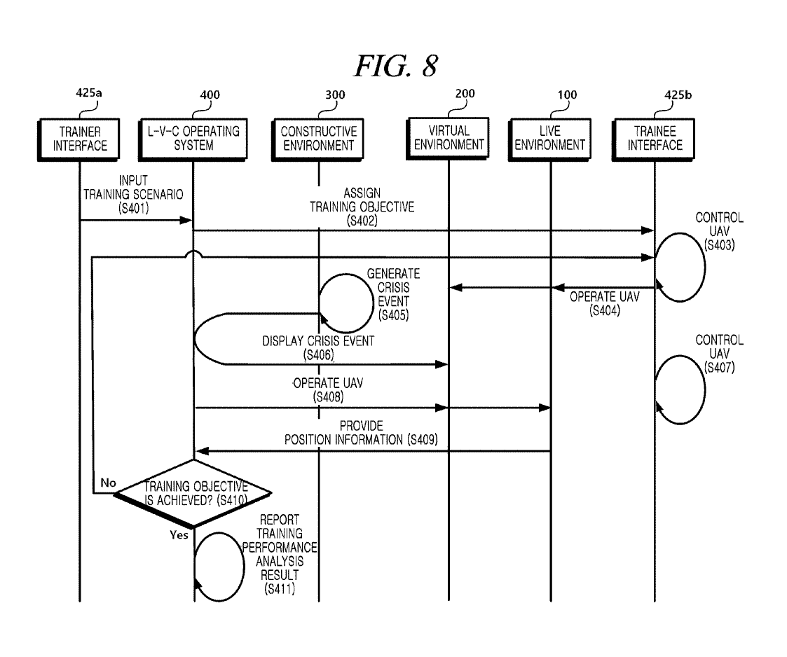

FIG. 8 is a flowchart illustrating a Live-Virtual-Constructive-based virtual mission training process in the L-V-C-based UAV training/testing method in accordance with an exemplary embodiment of the present disclosure. Referring to FIG. 8, as a training method for performing a virtual mission by Live, Virtual, and Constructive interworking, S401 to S403 are performed in the beginning in the same manner as S301 to S303 shown in FIG. 7, and then the actual UAV 1 of the Live environment 100 and a virtual UAV of the Virtual environment 200 are operated in response to a control input received through the trainee interface 425b (S404).

In this case, the actual UAV 1 of the Live environment 100 may be operated by directly receiving the control input, but is not limited thereto. The L-V-C operating system 400 may receive the control input and operate the actual UAV 1 of the Live environment 100.

Further, the virtual UAV of the Virtual environment 200 may be operated by performing the functions of the above-described synthetic environment control unit 410. For example, if the position-tracking module 411 receives information about a position/posture of the UAV of the Live environment 100, corrects the position/posture information of the UAV in consideration of a scale depending on spatial constraints of the Live environment 100 and then transfers the corrected position/posture information to the spatial information module 412, the spatial information module 412 may update and visualize a position/posture of the UAV, a position/posture of a mobile obstacle, changes in topography/environment, spatial information in the virtual space of the Virtual environment 200 in consideration of the corrected information.

During or after S404, if an event related to the UAV model occurs in the Constructive environment, the L-V-C operating system 400 may receive information about the event, such as a crisis, from the Constructive environment 300 and generate event information (S405), and then visually (or auditorily) displays the event on the virtual space of the Virtual environment (S406).

As a specific example, if the event propagation module 413 of the synthetic environment control unit 410 receives information about an event from the Constructive environment 300 and transfers information (e.g., weather information, topography/environment information, mobile obstacle information, stationary obstacle information, UAV information, etc.) changed by the event to the spatial information module 412, the spatial information module 412 may update and visualize a position/posture of a UAV, a position/posture of a mobile obstacle, changes in topography/environment, spatial information in the virtual space of the Virtual environment 200 in consideration of the corrected information in consideration of the changed information so as to display the event. As such, the event may be displayed as being visually expressed on the virtual space of the Virtual environment 200. Otherwise, the event may be displayed on the display of the Virtual environment 200 as simple information in the form of image or text.

In response to the event, such as a crisis, provided in S406, the trainee may make a control input with respect to the UAV 1 operated in the Live environment 100 through the trainee interface 425b (S407). The L-V-C operating system 400 receives the control input with respect to the UAV 1 and operates the UAV in the Live environment 100 and the virtual UAV in the Virtual environment 200 by direct control in consideration of effects of the control input and the event (S408).

To be specific, in S408, the UAV 1 may be operated by direct control matched with the event, such as a crisis, related to the actual UAV 1 of the Live environment 100 and the virtual UAV of the Virtual environment 200 by the synthetic environment control unit 410 of the L-V-C operating system 400. For example, an operation of the virtual UAV of the Virtual environment 200 may be controlled by the spatial information module 412 which receives changed information reflecting effects of the event from the event propagation module 413 and actual position/posture information of the UAV 1 of the Live environment 100 from the position-tracking module 411. Further, an operation of the actual UAV 1 of the Live environment 100 may be controlled by the model control module 414 which receives information updated according to the event from the spatial information module 412.

After S408, the L-V-C operating system 400 may collect at least one of position information of the UAV 1 operated in the Live environment 100 and position information of the virtual UAV of the Virtual environment 200 (S409). For example, the position information may be generated by the three-dimensional position-tracking sensor provided in the Live environment 100 and configured to find out an actual position/posture of the UAV 1, or may be received from the three-dimensional visualization program unit (software) of the Virtual environment 200. However, S409 is not limited to be performed only after S408. For example, position information of the UAV 1 of the Live environment 100 or position information of the virtual UAV of the Virtual environment 200 may be collected regularly while the other steps are performed, or may be collected frequently if necessary. Further, the L-V-C operating system 400 determines whether the training objective assigned in S402 is achieved on the basis of the collected position information (S410).

If it is determined in S410 that the assigned training objective is not achieved, the L-V-C operating system 400 is controlled to return to S403 and repeat S403 to S410 until the training objective is achieved.

If it is determined in S410 that the assigned training objective is achieved, the L-V-C operating system 400 reports a training performance analysis result to the trainer through the trainer interface 425a (S411) and then ends a Live-Virtual-Constructive-based virtual mission training process.

Meanwhile, the L-V-C-based UAV training/testing method in accordance with an exemplary embodiment of the present disclosure may be implemented in an application or in an executabe program command form by various computer means and be recorded in a computer-readable storage medium. The computer-readable storage medium may include a program command, a data file, and a data structure individually or a combination thereof.

The program command recorded in the computer-readable storage medium may be specially designed or configured for the present disclosure or may be known to those skilled in a computer software field to be used.

Examples of the computer-readable storage medium include magnetic media such as hard disk, floppy disk, or magnetic tape, optical media such as CD-ROM or DVD, magneto-optical media such as floptical disk, and a hardware device such as ROM, RAM, flash memory specially configured to store and execute program commands.

Examples of the program command include a machine language code created by a complier and a high-level language code executable by a computer using an interpreter. The hardware device may be configured to be operated as at least one software module to perform an operation of the present disclosure, and vice versa.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A L-V-C (Live-Virtual-Constructive) operating system for providing a L-V-C-based unmanned aerial vehicle (UAV) training/testing environment, comprising:
a synthetic environment control unit that exchanges information with a Live environment, a Virtual environment and a Constructive environment, and allows a UAV of the Live environment or the Virtual environment to interwork with the Live environment, the Virtual environment, and the Constructive environment,
wherein the synthetic environment control unit includes:
a position-tracking module configured to acquire position/posture information of the UAV of the Live environment and scale the position/posture information to correspond to a virtual space of the Virtual environment;
an event propagation module configured to receive information about an event if the event occurs in the Constructive environment and generate information changed by the event;
a spatial information module configured to generate updated information about an object and a space/environment in consideration of the scaled position/posture information of the UAV and the information changed by the event and apply the updated information to the Virtual environment and the Constructive environment; and
a model control module configured to generate a signal for controlling the UAV of the Live environment on the basis of the updated information.

2. The L-V-C operating system of claim 1,
wherein the model control module converts a UAV control command determined on the basis of the virtual space of the Virtual environment to the signal for controlling the UAV of the Live environment while reflecting spatial constraints of the Live environment.

3. The L-V-C operating system of claim 1,
wherein the spatial information module manages and provides position/posture information of a UAV and a mobile obstacle, and spatial/environmental information which are visualized in the virtual space of the Virtual environment.

4. The L-V-C operating system of claim 1,
wherein the updated information includes position/posture information of a UAV and a mobile obstacle and spatial/environmental information provided to the Virtual environment, and position/posture information of a UAV and a mobile obstacle and spatial/environmental information provided to the Constructive environment.

5. The L-V-C operating system of claim 1, further comprising:
a training support unit,
wherein the training support unit includes:
a scenario authoring unit configured to provide a scenario for a UAV trainee;
an event status injection unit configured to generate an event according to the scenario provided from the scenario authoring unit and provide the event to the Constructive environment;
a training result collection unit configured to collect an operation result of a trainee in response to the event from the Constructive environment;
a training result analysis unit configured to provide analysis information obtained by analyzing the collected training result; and
a user interface provided to see the scenario and the analysis information.

6. The L-V-C operating system of claim 1,
wherein the Live environment is a limited space that allows an actual UAV to be operated and includes a three-dimensional position-tracking sensor configured to provide information about position/posture of the UAV in real time,
the Virtual environment includes a display unit configured to provide a three-dimensionally visualized virtual space on a screen and a three-dimensional visualization program unit having a UAV visualization function, a mobile obstacle visualization function, a topography/landmark visualization function, and a weather visualization function, and
the Constructive environment includes a simulation engine configured to derive a physical interaction result between an object and a space/environment through a computer simulation.

7. A L-V-C-based UAV training/testing method using a L-V-C operating system of claim 1, comprising:
a first step in which the L-V-C operating system receives a scenario input by a trainer through a user interface and assigns a training objective according to the scenario;
a second step in which a UAV is operated in a Live environment according to a control input received through a trainee interface controlled by a trainee; and
a third step in which if an event occurs with respect to a UAV model in a Constructive environment, the L-V-C operating system receives information about the event from the Constructive environment and provides the information to the trainee interface, and receives a control input, with respect to the UAV in the Live environment, made on the trainee interface in response to the provided event and operates the UAV in the Live environment by direct control in consideration of effects of the control input and the event.

8. The L-V-C-based UAV training/testing method of claim 7, further comprising:
a fourth step in which the L-V-C operating system collects position information of the UAV operated in the Live environment and determines whether the assigned training objective is achieved on the basis of the collected position information; and
a fifth step in which if it is determined that the assigned training objective is not achieved, the L-V-C operating system is controlled to return to the second step and repeat the second step to the fourth step until the training objective is achieved.

9. The L-V-C-based UAV training/testing method of claim 8,
wherein in the fifth step, if it is determined that the assigned training objective is achieved, the L-V-C operating system reports a training performance analysis result to the trainer through a trainer interface and then ends a Live-Constructive-based crisis response training process.

10. A L-V-C-based UAV training/testing method using a L-V-C operating system of claim 1, comprising:
a first step in which the L-V-C operating system receives a scenario input by a trainer through a user interface and assigns a training objective according to the scenario;
a second step in which a UAV is operated in a Live environment according to a control input received through a trainee interface controlled by a trainee and the L-V-C operating system operates a UAV in a Virtual environment; and
a third step in which if an event occurs with respect to a UAV model in a Constructive environment, the L-V-C operating system receives information about the event from the Constructive environment and displays the event in a virtual space of the Virtual environment, and receives a control input made on the trainee interface in response to the displayed event and operates the UAV in the Live environment and the Virtual environment by direct control in consideration of effects of the control input and the event.

11. The L-V-C-based UAV training/testing method of claim 10, further comprising:
a fourth step in which the L-V-C operating system collects one or more of position information of the UAV operated in the Live environment and position information of the UAV operated in the Virtual environment, and determines whether the assigned training objective is achieved on the basis of the collected position information; and
a fifth step in which if it is determined that the assigned training objective is not achieved, the L-V-C operating system is controlled to return to the second step and repeat the second step to the fourth step until the training objective is achieved.

12. The L-V-C-based UAV training/testing method of claim 11,
wherein in the fifth step, if it is determined that the assigned training objective is achieved, the L-V-C operating system reports a training performance analysis result to the trainer through a trainer interface and then ends a Live-Virtual-Constructive-based virtual mission training process.
